(19) United States
(12) Patent Application Publication
(10) Pub. No.: US 2026/0321264 A1
(43) Pub. Date: Oct. 15, 2026

(54) Socially Assistive Robot For Robot Based Cognitive Behavioral Therapy And Cognitive Impairment Detection Using Natural Language Processing

(71) Applicant: DreamFace Technologies, LLC, Centennial, CO (US)

(72) Inventors: Mohammad H. Mahoor, Lone Tree, CO (US); Sean Mapoles, Lone Tree, CO (US); Lombe Chileshe, Lone Tree, CO (US); Matthew Hessler, Lone Tree, CO (US); Mohammad Mehdi Hosseini, Lone Tree, CO (US); Eshrat S. Emamian, Lone Tree, CO (US)

(73) Assignee: DreamFace Technologies, LLC, Centennial, CO (US)

(21) Appl. No.: 19/647,835

(22) Filed: Apr. 14, 2026

Related U.S. Application Data
(60) Provisional application No. 63/788,650, filed on Apr. 14, 2025.

(51) Int. Cl. G10L 15/26; G06V 40/16

(52) U.S. Cl. CPC G10L 15/26; G06V 40/174

(57) ABSTRACT

A companion robot is disclosed. In some embodiments, the companion robot may include a head having a facemask and a projector configured to project facial images onto the facemask; a facial camera; a microphone configured to receive audio signals from the environment; a speaker configured to output audio signals; and a processor electrically coupled with the projector, the facial camera, the microphone, and the speaker. In some embodiments, the processor may be configured to receive and analyze speech patterns from a user; receive audio input from the microphone and analyze speech patterns from a user; analyze linguistic characteristics from the audio input; and determine a user depression assessment based on the speech patterns and linguistic characteristics.

### GOVERNMENT RIGHTS

This invention was made with government support under award numbers 1 R44 AG059483 and 1SB1AG087755 awarded by the National Institute on Aging a division of the National Institute of Health (NIA/NIH). The government has certain rights in the invention.

### BACKGROUND

Alzheimer's disease (AD) and related dementias (ADRD) are critical public health issues affecting millions of older adults, presenting significant challenges not only for the individuals diagnosed but also for their families and caregivers. These conditions lead to a progressive decline in cognitive functions, which severely impacts the daily lives and independence of those affected. The onset of AD/ADRD typically begins with Mild Cognitive Impairment (MCI), a condition marked by subtle cognitive changes that may include early memory loss, difficulties with verbal communication, and impairments in visual and spatial perception. While MCI itself does not always progress to full-blown Alzheimer's or another dementia, its presence is considered a major risk factor. As AD/ADRD worsens, individuals may experience increasingly severe cognitive and functional decline, affecting their ability to live independently. Preventing or slowing the progression from MCI to more advanced stages of dementia is of significant importance, not only for the well-being of the individuals but also for reducing the societal and healthcare burden. Research has indicated that engaging in mentally stimulating social activities, such as puzzles, learning new skills, and participating in community-based programs, can play a crucial role in maintaining brain health and slowing cognitive decline. Furthermore, regular physical exercise and maintaining strong social connections have been shown to support brain function and may delay the onset or progression of dementia. Thus, promoting mental engagement, physical activity, and social interaction is vital for older adults at risk for or experiencing MCI, offering a promising approach to mitigating the effects of AD/ADRD.

Depression is the most prevalent mental health disorder among older adults in the United States, significantly impacting their overall well-being, quality of life, and physical health. As the aging population continues to grow at an unprecedented rate, the burden of depression among older adults is expected to rise sharply. A study projected that the U.S. population over the age of 65 would increase by 125.3%, growing from 179.8 million in 2005 to 225.9 million by 2050. In parallel, the number of older adults diagnosed with major depressive disorder is expected to increase by approximately 116.8%, rising from 36.4 million in 2005 to 82.0 million in 2050. This dramatic demographic shift, combined with economic pressures and healthcare system limitations, is contributing to an already evident shortage of mental health providers who specialize in geriatric care. As the demand for mental health services escalates, this workforce shortage is anticipated to become more severe over time, leading to reduced access to care, longer wait times, and a decline in the quality of services available to older adults. Without strategic investment in geriatric mental health infrastructure and workforce development, the growing needs of this vulnerable population may go unmet, exacerbating the impact of depression and other mental health conditions in later life.

### SUMMARY

The present disclosure generally relates to a socially assistive companion robot configured to interact with a user through speech, facial expressions, and physical movements, and more particularly to systems and methods for using artificial intelligence, natural language processing, and multimodal sensing to assess and mitigate depression and cognitive impairment in a user.

In some embodiments, the companion robot includes a head having a facemask and a projector configured to project facial images onto the facemask in order to communicate lifelike facial expressions to a user. The companion robot further includes one or more sensors for receiving environmental input, including a microphone for capturing audio signals comprising a user's speech and a facial camera for receiving video signals indicative of a user's face. One or more speakers are provided to deliver audio responses to the user. A processor is electrically coupled with the projector, facial camera, microphone, and speaker, and executes instructions stored on computer-readable media to control operation of the companion robot.

In operation, the processor may receive audio input from the user through the microphone and identify speech patterns and linguistic characteristics present in the audio input. Using these speech patterns and linguistic characteristics, the processor may determine a user depression assessment indicative of a severity level of depression of the user. Based on the depression assessment, the processor can generate an appropriate response comprising text and/or audio output intended to alleviate depression and deliver the response to the user as speech output through the speaker.

In some embodiments, the companion robot further receives video input from the facial camera indicating the user's face and identifies one or more facial expressions of the user. The determination of the user depression assessment may be further based on the identified facial expressions. The processor may determine an emotional state of the user by combining speech-based features with visual facial expression information, and the depression assessment may additionally be based on the determined emotional state. In such embodiments, the generated response may include both spoken text and facial images selected to improve the emotional state of the user, with the facial images being projected onto the facemask in synchronization with speech output.

In some embodiments, the companion robot may generate the response through a ChatBot. A transcription of the audio input may be provided to the ChatBot of the companion robot, and wherein the response may be generated by the ChatBot based on the transcription. The ChatBot may include a plurality of personalities, and a personality of the plurality of personalities may be selected based on a mood, depression assessment, and/or cognitive impairment assessment of the user. The personality of the ChatBot may be further based on summaries of past conversation data generated during conversation with the user to further customize the personality of the ChatBot. The personality may be predefined based on a specific topic of interest, such as a comedic, scientific, religious, or academic topic of interest.

In some embodiments, the speech patterns and linguistic characteristics are identified by providing the speech input to one or more natural language processing (NLP) algorithms. The companion robot may further employ a large language model-based dialogue management system to produce natural, adaptive interactions with the user. The processor may evaluate user engagement during interactions and produce reciprocal mirroring of the user's engagement through speech, facial expression, and motion.

The companion robot may be further configured to deliver robot-based cognitive behavioral therapy (rCBT). In such embodiments, the processor presents cognitive behavioral therapy questions to the user through the speaker and/or a touchscreen display communicatively coupled to the processor, and receives user responses through the microphone and/or the touchscreen.

In other embodiments, the companion robot is configured to assess cognitive impairment rather than, or in addition to, depression. The companion robot may include a facial display, a neck mechanism mechanically coupled to the head, and a processor that provides the user's speech input to an AI software application. The AI software application analyzes speech patterns and linguistic characteristics to perform a cognitive impairment assessment indicative of a level of cognitive health or cognitive function of the user. Based on this assessment, the processor generates and delivers spoken responses intended to mitigate cognitive decline.

The AI software application may analyze a set of spoken words to identify indicators of mild cognitive impairment and may further identify linguistic, acoustic, and prosodic patterns associated with cognitive decline. In some embodiments, an AI-based NLP algorithm automatically assesses language frailty from speech input. Generated responses may include both speech and facial images, with facial images selected to synchronize with speech output.

In some embodiments, the companion robot further includes a 3D camera configured to capture depth images representing a visual environment and range data. The processor may detect acoustic patterns, language features, and digital biomarkers from the audio input and 3D images, and monitor the cognitive health of the user based on such multimodal data. In some embodiments, the companion robot may use the 3D camera to detect a fall of the user. The companion robot may detect a pose of the user and to assign a fall status of the user, wherein the fall status is one of “fall,” “near-fall,” “instability,” or “activity of daily living” (ADL).

The companion robot may detect a pose of the user by providing an image from the 3D camera (or another camera, such as a 2D camera) to a skeleton detection algorithm to obtain an extracted skeleton and may additionally provide the extract skeleton to a fall detection model to determine the pose. The fall detection model may comprise a machine learning model. The companion robot may notify a caregiver when a fall of the user is detected.

The companion robot may further include a network interface for communicating speech patterns, linguistic characteristics, or assessment results to remote systems or caretakers. The companion robot may additionally be configured to engage the user in conversations that encourage increased speech production and maintain ongoing interaction. Cognitive impairment assessments or related notifications may be communicated to a caregiver. The companion robot may comprise an AI agent that organizes and coordinates multi-step tasks for engaging with the user, and the response may be further based on output from the AI agent.

In further embodiments, the companion robot includes a torso coupled to the head via a neck mechanism and includes a pair of arms and shoulders mechanisms configured to generate arm movements. The processor may generate a synchronized response to interact conversationally with a user and/or based on the cognitive impairment assessment. The synchronized response may include coordinated conversational audio output, facial images presented on the facemask with different expressions that may change accordingly, and a gesture including robotic movement, such as neck movements and/or arm movements, which may be generated to mitigate the cognitive decline of the user and/or to further conversation with the user. The response can include synchronized speech output, facial expressions presented to the facemask, and robotic movement generated by at least one mechanism of the companion robot, such as neck movements generated by the neck mechanism and/or arm movements generated by the arms and shoulders mechanisms. In some embodiments, arm movements are selected to instruct the user in physical activities intended to mitigate cognitive decline.

Collectively, the disclosed systems provide an integrated, physically present, socially assistive robotic platform capable of using artificial intelligence, natural language processing, multimodal sensing, and expressive behaviors to assess mental health and cognitive status and to deliver personalized, empathetic interventions to support emotional and cognitive well-being.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 is a front view of a companion robot with an exterior skin according to some embodiments.

FIG. 2 is a transparent, front view of a companion robot without an exterior skin according to some embodiments.

FIG. 3 is a block diagram of various components of a companion robot architecture according to some embodiments.

FIG. 4 is a block diagram illustrating a plurality of processing modules of the controller according to some embodiments.

FIG. 5 is a sideview of a head according to some embodiments.

FIG. 6 shows an illustrative computational system for performing functionality to facilitate implementation of embodiments described herein.

FIG. 7 is a flowchart of a process for controlling the speech and/or affect of a companion robot (e.g., companion robot) according to some embodiments.

### DETAILED DESCRIPTION

Current robot technologies have yet to reach the full emotional and social capabilities necessary for rich and robust interaction with human beings, but Robots that can tackle the problems outlined in this disclosure may be extremely useful. Robots with the ability to provide robot-based cognitive behavioral therapy (rCBT) and cognitive impairment detection may be useful for interacting with people in home situations, such as elderly people, patients with Alzheimer's disease, dementia and/or depression, children with autism, or others who may benefit from an interactive social robot. Robotic heads that can model natural face-to-face communication with individuals in different social, learning, and therapeutic contexts may be desired.

Some embodiments of this disclosure may include a companion robot (or socially assistive robot—SAR) that can socialize and interact with users to tackle the pressing issue of limited health services for older adults. For example, a companion robot may bridge the gap in elder care by delivering evidence-based interventions to enhance their quality of life and wellbeing. Implementing expertise spanning computing, machine learning, psychiatry, geropsychology, and healthy aging research, some embodiments integrate robot-administered cognitive behavioral therapy (rCBT) into a SAR's capabilities to alleviate and address depression in older adults. Some embodiments of this disclosure may present a valuable resource for clinicians and individual users in large older adult communities, offering mood disorder testing, depression risk assessment, and rCBT treatment for improved wellbeing.

Embodiments of the SAR include an innovative life-like robotic character with state-of-the-art computer graphics that project and animate onto a realistic 3D face. To effectively socialize, the SAR is designed to track the user's body and face, recognize their expressions, and react appropriately with communicative facial expressions and empathetic dialogue generated by a dialogue management system. Embodiments of the SAR can express facial expressions, track a user's body and/or face, recognize a user's expressions, and/or react appropriately to the user's emotional state. The companion robot may also provide mental stimulation and/or companionship for its users through conversation, cognitive games, engagement in simple physical activities, reminiscence therapy, and/or music therapy, etc.

In some embodiments, activities enabled by the companion robot may assist elderly individuals with declining memory, cognition and attention. In some embodiments, the companion robot may engage a user in a wide range of activities such as brain games, music play, and seated Yoga, maintain each individual's daily schedule, and can stimulate elderly individuals' brain. In some embodiments, the companion robot may also provide reminders about daily activities and medications. In some embodiments, the companion robot can analyze seniors' behaviors and alert caregivers/nurses of a need. The companion robot may generate a wellness report at regular intervals (e.g., weekly) of the health (e.g., physical, mental, emotional) of the user to caregivers. For example, the wellness report may provide a snapshot of the user's physical and mental health, the rate of cognitive decline, and the rate of change in the above parameters. Embodiments of the SAR include a tablet on the SAR's torso to provide a convenient interface for visual aids, emergency alerts, video chats with loved ones, music and reminiscence therapy, cognitive games, and physical activity demonstrations like seated yoga.

In some embodiments, a companion robot may support one or more of the following activities: coordinated movements of the robots' head and neck; managing animation and visual speech during conversations; recognizing users' emotions via speech, sentiment analysis, and/or facial recognition; running cognitive games; reminding users of scheduled activities; alerting staff (e.g., based on absence of any activity for a period of time or based on emotional responses); empathize with users via facial expressions, head movements, arm movements, and/or speech; video calling; converse with a user about various topics; answer user questions; instruct a user about physical exercises; and/or providing activity reports.

In some embodiments, a companion robot may include a dialogue management system that integrates emotional intelligence into spoken dialogue with users. For example, rather than simply listening to, understanding, and responding to users' speech, a companion robot may interpret a user's affect (e.g., engagement, frustration, excitement, tone, facial expression, etc.), and produce contextually appropriate responses, facial expressions, and/or neck movements.

Embodiments of the SAR include an innovative natural language processing (NLP) algorithm to automatically assess for the presence and severity of depression. An NLP-based model is a type of artificial intelligence system that uses natural language processing techniques to understand, interpret, and generate human language. NLP is a branch of computer science and linguistics that focuses on enabling machines to process and respond to text or speech in a way that is meaningful and useful. These models are designed to perform tasks such as language translation, text summarization, sentiment analysis, speech recognition, and conversational interaction, like those used in chatbots or virtual assistants. Modern NLP models are often built using machine learning or deep learning, and are trained on large datasets to learn language patterns, grammar, and context. Examples of widely known NLP models include BERT, GPT, T5, and RoBERTa. These models may play a crucial role in improving human-computer interaction. The algorithm may be created from publicly available databases used for depression assessment or private datasets and continuously measure participant depression severity based on speech patterns and linguistic characteristics used during rCBT sessions. The algorithm may produce a severity score that can be compared with participant MINI, PHQ-9, GAD-7, and GDS-30 scores to determine the algorithm's accuracy.

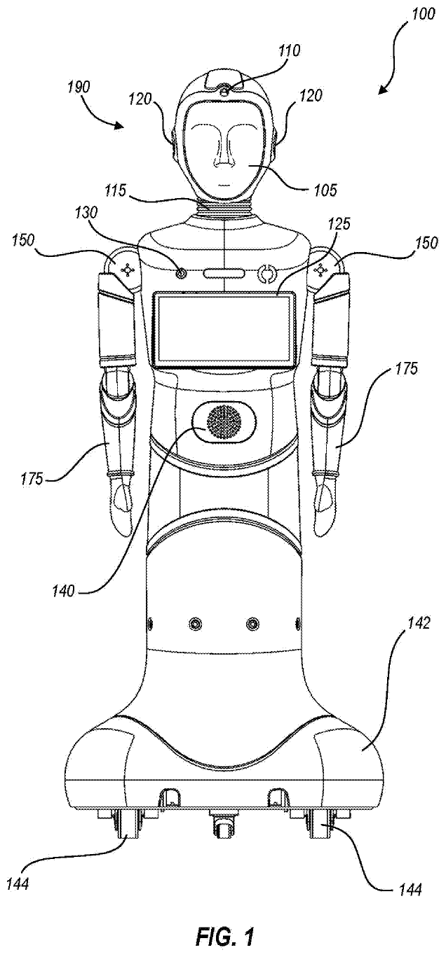

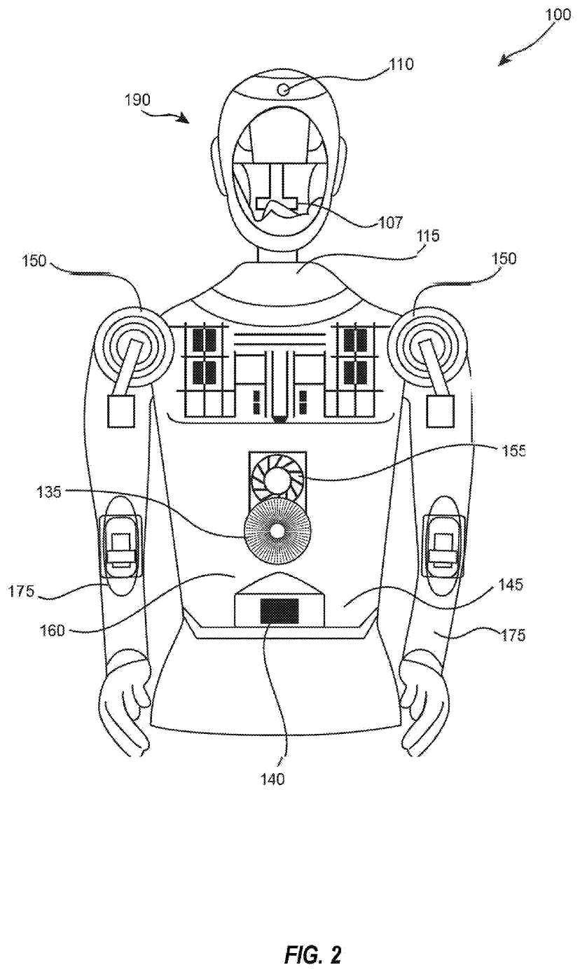

FIG. 1 shows the companion robot 100 with an exterior skin and FIG. 2 shows the companion robot 100 without the exterior skin. The companion robot 100 may include a facemask 105, a projector 107, a facial camera 110, a neck mechanism 115, indicator LEDs 120, a user interface 125, a 3D camera 130, a microphone 135, speaker(s) 140, a controller 145, a network interface, shoulder mechanisms 150, cooling fan 155, a power inlet 160, a base 142, and/or wheel 144.

In some embodiments, the projector 107 and/or the facemask 105 may include the screens and/or projectors described in U.S. Pat. No. 9,810,975, titled “Rear-projected life-like robotic head”, which is incorporated into this document by reference for all purposes. In some embodiments, the projector 107 may include any number of lens, mirrors, and/or other optical components.

In some embodiments, the facemask 105 may be disposed at the front of the head 190. The facemask 105, for example, may be removable and/or interchangeable with other face masks. In some embodiments, the facemask 105 may be a translucent face mask onto which the facial images may be projected. In some embodiments, the facemask 105 may be constructed or molded from a clear plastic and/or a surface (e.g., a rear surface of the facemask 105 disposed towards an interior of the head 190) may be coated with projection paint. In some embodiments, the facemask 105 may be three dimensional, which may, for example, reduce the Mona Lisa Effect that may result when 3D objects are displayed on 2D surfaces. For example, the facemask 105 may include three dimensional features such as a nose, cheeks, lips, a forehead, etc.

In some embodiments, facial images may be projected onto the back surface of the facemask 105. For example, facial images may be created using a character animation application and/or may include natural speech and facial expressions that can be projected on to the back of the facemask 105. The facial images may, for example, be cartoon-like, animated, and/or photorealistic. In some embodiments, the character animation application may calibrate the facial images for a particular face mask. The projector 107, for example, may project life-like three dimensional facial models onto the facemask 105 that can express rich natural speech and/or facial expressions (e.g., through character animation).

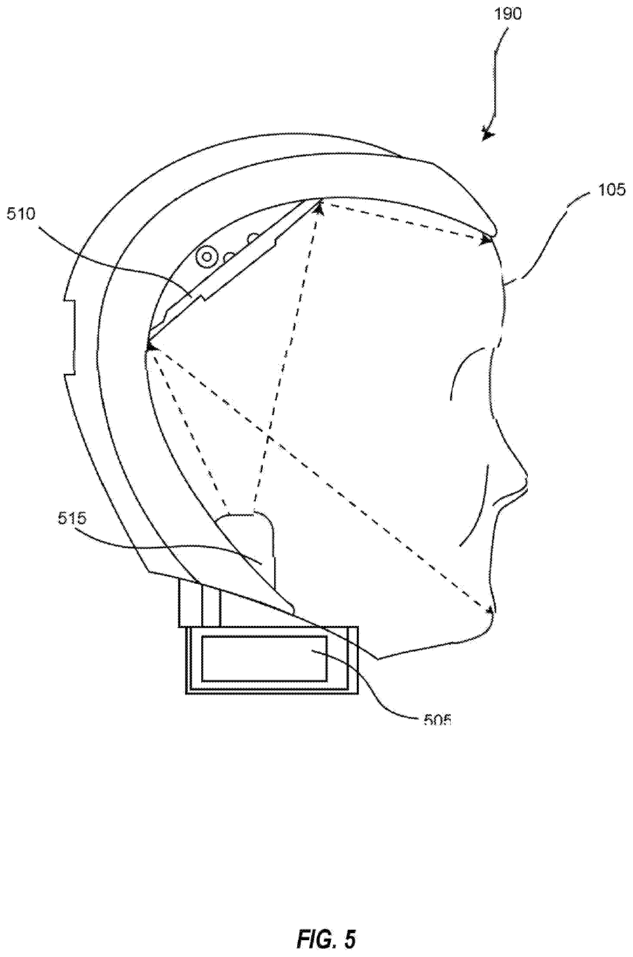

In some embodiments, the projector 107 may use rear-projection to project the facial image on the face mask as shown in FIG. 5. In some embodiments, the projector may include a lens and/or a mirror with a wide-projection angle, such as, for example, a fish eye lens. In some embodiments, a projector may be portable and/or miniature. In some embodiments, the projector may be high-resolution and/or high-luminosity. In some embodiments, the projector may be able to display a resolution of approximately 1200 by 800 pixels and may have a contrast ratio of approximately 10,000 to 1. Some embodiments may include a projector that may be capable of up to, for example, 300 ANSI Lumens under normal indoor illumination conditions. The projector may, for example, include a Dell DLP M110 portable projector (e.g., a DLP projector) or other similar DLP projector. The projector may also include a portable projector such as, for example, a smart pico projector manufactured by AAXA Technologies or the like.

In some embodiments, the projection projector 107 may be disposed within the head 190 as shown in FIG. 5. For example, the projector may be disposed near the base of the head 190 (e.g., near the neck) and/or may project images onto a mirror 510 disposed near the back or the top of the head 190. The mirror 510 may reflect images onto the facemask 105. In some embodiments, the facemask 105 and/or the projection projector 107 may be replaced with an LED display that can be used to display facial images. The LED display may be disposed on the front of the head 190.

In some embodiments, the facial camera 110 may be disposed within the head 190 and/or may include any type of digital camera that can record images and/or video. The facial camera 110 may, for example, be focused and/or directed to collect images of a human within 2 to 10 feet from the companion robot. In some embodiments, the facial camera 110 may include an RGB web camera, for example, that captures images at 30 frames per second and/or with VGA resolution.

In some embodiments, the neck mechanisms 115 may include motors, gears, pulleys, etc. that can be used to move the neck and/or head 190 through two, three, or six degrees of freedom. In some embodiments, the neck mechanism may include six prismatic joints that actuate rods connected to the head through universal and/or spherical joints. The neck mechanisms 115, for example, may also translate the head forward and backwards as well as rotate (e.g., rotate the head back in expression of disbelief). In some embodiments, the center of rotation of the head can also be shifted along the cervical spine to produce rotations about the centroid of the head or the base of the neck for different effect.

Studies have shown that head motion can be useful in communicating a physical-emotional response including, for example, affirmation, impatience, disbelief, desire to speak, and/or empathy. The neck mechanism 115 may provide head motion that can communicate such a physical-emotional response. The neck mechanisms 115, for example, may include any or all the components described in U.S. Pat. No. 9,810,975, titled “Rear-projected life-like robotic head”, which is incorporated into this document by reference for all purposes.

In some embodiments, the neck mechanisms 115 may include multiple degrees of freedom. These degrees of freedom can include rotation of the head 190 about the center of the head 190, rotation of the head 190 about the base of the neck, back and forth translation, side to side translation, head tilt, side to side tilt, etc. In some embodiments, the neck mechanisms 115 may include a pan/tilt unit that can produce yaw and pitch rotations of the head 190.

In some embodiments, the indicator LEDs 120 may indicate whether the companion robot 100 is on and/or functioning. In some embodiments, LEDs 120 can communicate various status information about the function of the companion robot 100 such as, for example, error messages, low power messages, alerts, etc.

The user interface 125 may include any type of display such as, for example, a touchscreen display, a tablet device, etc. For example, the user interface 125, may include an Apple iPad or a Microsoft Surface or any other type of device that can present data or information on display and/or receive inputs from a user through a touchscreen display. In some embodiments, the user interface 125 may provide a platform that allows a user to participate in cognitive games, reminiscence and music therapy, video chat with loved ones, etc. In some embodiments, the user interface 125 may provide a platform that allows a user to participate in audio-video calls (e.g., video conferencing) with another remotely located individual.

In some embodiments, the 3D camera 130 may include any type of three dimensional camera such as, for example, a Kinect RGB-D camera, an Intel RealSense camera (e.g., D435, D415, SR300, etc.), Orbbec Astra Mini, Asus Xtion2, or a similar camera. The 3D camera 130 may include a camera that produces a 2D image and the range to points in a scene from a specific point for each pixel. For example, the image may include, for example, RGB (red, green, blue) values and range values for points in the scene. The 3D camera 130 may, for example, provide 3D data to the controller 145 about the position of the user's body position, object localization within the scene or environment, etc. The 3D images (or video) may be electronically transmitted to the controller 145.

The microphone 135 may include any type of microphone that can collect audio. The microphone may include an analog-digital converter that can convert an audio signal to a digital audio signal. The digital audio signals may be transmitted to the controller 145. The speaker(s) 140 may include any type of speaker. The speakers, for example, may be used to produce voice audio signals (i.e., speech output) provided, for example, by the controller 145.

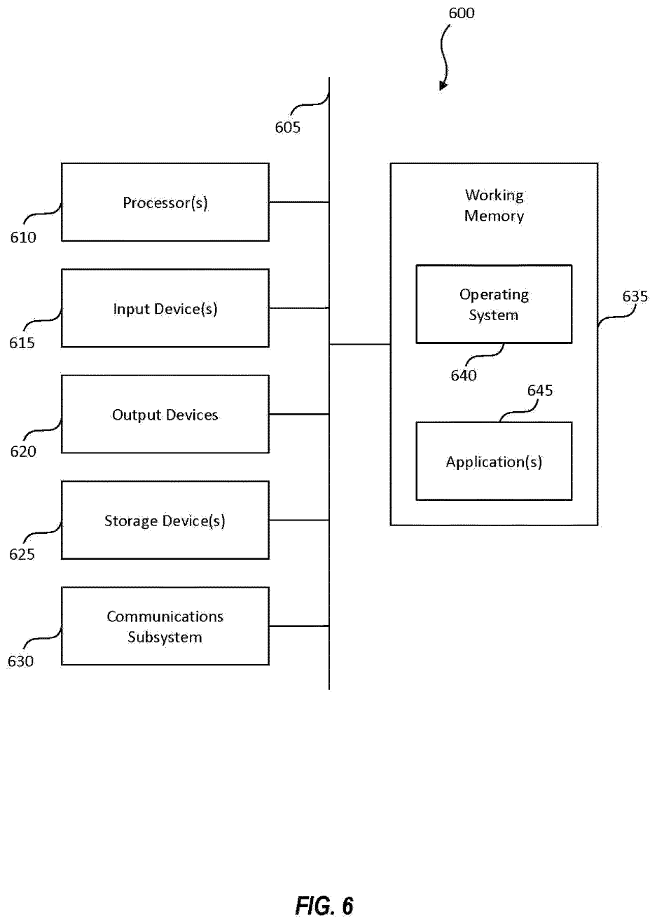

In some embodiments, the controller 145 may include any or all components of computational system 600 shown in FIG. 6. In some embodiments, controller 145 may control the operation of the companion robot 100. The power inlet 160 may provide power to the various components of the companion robot 100. The cooling fan 155 may be used to cool various components within the companion robot 100. In some embodiments, a power supply or custom power distribution board may be used to distribute power to the various components that require electrical power. The companion robot 100 may include a (e.g., rechargeable) battery that may provide powered operation to the companion robot 100 when the companion robot 100 is not plugged in to a power outlet. The battery may enable powered operation of the companion robot 100 for an extended period of time such as, for example, four to six hours. The battery may charge when the companion robot 100 is plugged in to a power outlet.

In some embodiments, the controller 145 may include algorithms, processes, and/or software that interacts with a user via the various components of the companion robot 100. For example, the controller 145 may maintain a user's daily schedule, stimulate a user's brain (e.g., with engaging dialogue, music, or games), provide reminders about daily activities and/or medications, analyze a user's behavior, alert caregivers/nurses of a need, play games with a user, empathize with a user, carry on a conversation with a user, instruct a user regarding physical activities. The companion robot 100 can engage a user individually in a game (e.g., a quiz, virtual board games, video games, etc.) or may engage a group of users in a game. For example, the companion robot 100 may facilitate multiple users in a game (e.g., Bingo, Tune Quest, etc.) to stimulate the users' brains. The game may be cooperative or competitive. The companion robot 100 may receive input from the one or more users via audio input and/or through a touchscreen, or other input mechanism. For example, the companion robot 100 may distinguish between input from different users based on the users' voices (e.g., based on a voice profile). Similarly, the companion robot 100 can lead multiple users together in a physical activity (e.g., seated Yoga) to stimulate brain activity.

In some embodiments, the controller 145 may include algorithms, processes, and/or software that interacts with a user via the various other components of the companion robot 100 to provide robot-based cognitive behavioral therapy (rCBT). According to some embodiments, a companion robot 100 can create a robust therapeutic alliance with the user to generate a collaborate, trusting bond between the companion robot 100 and the user. This can be achieved by leveraging a companion robot's 100 physical presence and interactive content elements. The rCBT of a robot enabled program can provide distinct advantages over internet-based cognitive behavioral therapy (iCBT) and other forms of remote therapy. For example, some studies demonstrate that physically present robots are more persuasive, receive more attention, and are perceived more positively than exclusively virtual agents when disseminating identical information. The disclosed rCBT approach may take advantage of companion robot's 100 physical presence and touch screen with interactive content elements such as press buttons, drag and drop word games, and text displays. The companion robot's 100 physical presence, unconditional positive regard, and the interactive content presented in rCBT may create a strong therapeutic combination, and a motivational environment in which patients are willing to approach the change needed to address depressive symptoms. Some embodiments of this disclosure may utilize rCBT to alleviate the symptoms of depression among older adults.

Some embodiments of this disclosure may measure depression and/or cognitive status using the PHQ-9, the GDS-30, and/or the Saint Louis University Mental Status (SLUMS) Examination. In some embodiments, the companion robot 100 can administer a face scale mood evaluation to inform a day-to-day sense of mood pre-and post-intervention. Some embodiments of this disclosure may record and analyze users' verbal responses.

Some embodiments of this disclosure may use an Artificial Intelligence Markup Language (AIML) dialogue management system to produce more seamless interaction between the companion robot 100 and a user. Some embodiments of this disclosure may evaluate and analyze how thoughts, activities, and interactions with others affect the mood of a user.

Some embodiments of this disclosure may produce a novel autonomous delivery of a psychotherapy through a socially assistive robot. This allows for automated care through a companion robot 100. The user and the companion robot 100 can build a therapeutic alliance based on empathic affectual response, reciprocal mirroring of positive feelings, and interactive content. The companion robot 100 can, in real-time, evaluate user engagement and respond to intrinsic and/or extrinsic motivational deficits with encouragement. The companion robot 100 can monitor the user's progress and the quality of their learning experience through periodic evaluation of learning outcomes. The companion robot 100 can use rCBT content to support late-life learning and consider the heterogeneous and wide-ranging needs of older adults. Older adults generally value collaborative learning and learn best in motivational environments where they are encouraged to set measurable goals, environments where they self-regulate, and in environments where they are given the autonomy to determine their own learning process.

Some embodiments of this disclosure may prioritize a robust therapeutic alliance with high levels of user engagement concurrent with rCBT concept-and skill-building and ensure user engagement through maximal content interaction and relationship building (e.g., game play, banter, personalized content).

Some embodiments of this disclosure may include a companion robot 100 that reinforces learning outcomes at the end of each interactive session with word games and quizzes. Word games can mimic cognitive leisure activities (e.g., crossword puzzles, board games, reading) which have been shown to improve working memory for older adults. Word games and quizzes serve the dual function of creating user engagement and identifying areas where the user is struggling. Outcomes identified as poorly understood (e.g., in moments where the user has been determined to have poorly understood the activity) can be repeated or explained using different examples and/or terminology.

Some embodiments of this disclosure may allow a user to select from a list of outcome goals they may wish to pursue within the variable content portions of the rCBT program. Goal examples may include “learn about caring for myself”, “work with difficult thoughts and emotions” or “increase positive activities.” The companion robot 100 may be configured to operate based on the user goal selection. The companion robot 100 can motivate users through internal and external reward systems. Internal reward motivation can be developed by identifying and targeting individual user desires. For example, a user who selects an outcome goal of “learn about caring for myself” can be routinely prompted with reflective questions that inspire internal motivation such as “why is this important to you?” and “why is this something you have chosen to address now?” External rewards can be delivered in the form of points that the user can accumulate when they complete sub-processes within each content module. Additionally, the companion robot 100 can deliver verbal content normalizing the difficulty of acquiring new skills and encouraging users to persist through conceptual roadblocks. The companion robot 100 can motivate users by modeling unconditional positive regard (UPR) with frequent smiling and other positive facial expressions.

Some embodiments of this disclosure may utilize artificial intelligence (AI) and machine learning (ML) to identify complex patterns within text or speech data and create models to recognize these patterns. NLP may facilitate an analysis of speech characteristics (tone, acoustics) and can be used with AI and ML approaches to measure the severity of assessed depression. Speech linguistic characteristics including the use of specific adverbs and pronouns may be used to diagnose depression. Artificial intelligence (AI), machine learning (ML), and NLP are important components of any objective mental illness assessment tools. An approach that leverages AI/ML/NLP may benefit older adults specifically due to higher rates of comorbidity like cognitive impairment that can easily mask mood disorder symptoms.

Some embodiments of this disclosure may use an NLP-based algorithm for depression assessment and measurement from publicly available databases. The algorithm can continuously measure participant depression severity based on speech patterns and linguistic characteristics used during rCBT sessions. The algorithm-produced severity score will be compared with participant MINI, PHQ-9, and GDS-30 scores to determine the algorithm's accuracy. Behavioral and social markers of language, voice, speech patterns, and conversational behaviors have predictive power in assessing depression. To use different information and signal modalities, the companion robot 100 may employ a hybrid approach encompassing language patterns (e.g., a user's dialogue may be converted to text using automated speech recognition in Ryan®), speech, and prosody features to build a transformer model to assess and measure depression severity. Some embodiments of this disclosure may use an end-to-end deep neural network to build the model. The advantage of a deep end-to-end model is the elimination of extracting features (or hand-crafted features), training separate classifiers, and the use of fusion algorithms for building a system. The companion robot 100 may use state-of-the-art deep learning models such as Bidirectional Encoder Representations from Transformers (BERT) that are end-to-end and rely on automatic neural-based features extracted by such models.

BERT transformer models may include an encoder block, which may take the input sequence and map it into a higher dimensional space (n-dimensional feature vector). These transformers can employ an attention mechanism, which analyzes the input sequence and determines the significance of each part at every step. This means that similar to reading a text, the attention mechanism may enable the model to focus on the current pattern while also considering other important patterns and keywords to provide overall context. Recent research has combined BERT language models with Convolutional Neural Networks (CNN) for depression detection, creating a robust tool for capturing intricate language and speech patterns indicative of mental disorders. The CNN layer built on top of BERT may be utilized to extract local features and conduct classification. To alleviate computational costs, RoBERTa, a state-of-the-art bidirectional transformer pre-trained using a combination of masked language modeling and sentence prediction may be selected as the BERT transformer. While RoBERTa excels in tasks like predicting masked tokens and understanding natural language, it may not be optimal for text generation. Thus, a CNN feedforward layer may be integrated on top of RoBERTa for the classification task and to initialize RoBERTa with random weights.

Some embodiments of this disclosure may utilize various datasets including public datasets to train and evaluate, but internal datasets may be additionally, or alternatively, utilized. The datasets can be split into sets for training, validation, and testing, or may be chosen at random.

Some embodiments of this disclosure may utilize user engagement and measurement and may utilize spoken words, tablet display, and SAR's facial expressions. Participant engagement can be assessed through quantitative analysis of spoken responses and facial expressions. Automated natural language analysis may be employed to determine the average sentence length of open-ended question responses and conduct sentiment analysis to evaluate sentiments at a sentence level. Further, in some embodiments, a user's smile rate and negative expressions during interaction with the companion robot 100 may be measured. Participant enjoyment of the companion robot 100 and rCBT can be gauged. Some embodiments further assess spoken words, touch interactions with the screen, response time, task success rate, user satisfaction surveys, and analyze other usage patterns.

In some embodiments, the arms and shoulders mechanisms 150 may include motors, gears, pulleys, etc. that can be used to provide arm and hand emotive motions. Research has shown that humans who use emotive hand gestures while speaking are often viewed as warm, agreeable, and/or energetic whereas those with less animated speech are perceived as logical, cold, and/or analytical. The arms and shoulders mechanisms 150 may provide four degrees of freedom to the arms 175 that may be used to actively control the arms 175. In some embodiments, the arms and shoulders mechanism 150 can be used to create gestures during dialogue. These gestures, which may include robotic movement of the companion robot 100, may, for example, make interactions with the companion robot 100 more natural, physical, and/or animated.

In some embodiments, the arms and shoulders mechanisms 150 may also be used to demonstrate upper body exercises. In some embodiments, the arms 175 and/or shoulders may include elastic joints and/or limbs to mitigate harm from collisions and/or risk of injury.

In some embodiments, the (e.g., one or more) arms and shoulders mechanisms 150 may include flexion/extension and/or abduction/adduction motions of the shoulder that may be actuated by a differential gear mechanism with counterweight springs to counter the static weight of the arm and reduce the motor power required. In some embodiments, medial and/or lateral rotation of the shoulder may be produced by a servo motor mounted in the upper arm. Elbow flexion/extension, for example, may be produced by a servo motor mounted in the elbow. In some embodiments, pneumatic artificial muscles (PAMs) may be used to actuate the arms. PAMs are characteristically similar to human muscles and can be used to create more natural, human-like arm motion.

In some embodiments, the arms and shoulders mechanisms 150 may include safety features such as, for example, a ring of sensors on its head to determine if any obstacles are in its workspace and slows or halts arm movement accordingly. In some embodiments, the arms and shoulders mechanisms 150 may include a series elastic actuators that can sense interference from obstacles and act as shock absorbers in a collision to minimize damage. In some embodiments, the arms may include a clutch mechanism that releases the arms from the drive motor in response to hitting an obstacle and/or if the motor exerts additional torque.

In some embodiments, the arms and shoulders mechanisms 150 may or may not be included with the companion robot 100. In some embodiments, the arms and shoulders mechanisms 150 may be passive arms and/or shoulders. In some embodiments, the arms 175 may include proximity and/or tactile sensors. Signals from the sensors may be used to trigger movement of the arms 175 and/or shoulders to avoid or mitigate injury. The companion robot 100 may include a number of other components.

The companion robot 100 may be supported by a base 142 which may support the torso of the companion robot 100. The base 142 may be weighted to provide stability to the companion robot 100 so as to reduce or prevent the incidence of falls of the companion robot. The base 142 may comprise a plurality of wheels 144, for example, configured to contact a ground surface, to facilitate movement of the companion robot 100. One or more of the plurality of wheels 144 may pivot (e.g., pivot in 360 degrees) to improve the moving capability of the companion robot 100. The companion robot 100 may thus be pushed (e.g., by a caregiver) to a desired position. In some embodiments, one or more of the plurality of wheels 144 may be motorized to further facilitate movement of the companion robot 100. One or more of the plurality of wheels 144 may be steerable. For example, the companion robot 100 may be steered remotely (e.g., through a network or a Bluetooth connection to a remote device), such that the companion robot 100 can be steered to a desired position (e.g., by a remote caregiver). In some embodiments, the companion robot 100 may be driven autonomously via an AI software program. For example, the companion robot 100 may (e.g., when autonomous driving is enabled) autonomously approach a patient to engage in conversation.

In some embodiments, the companion robot 100 is configured to do cognitive impairment detection or assessment using natural language. In some embodiments, the companion robot 100 may utilize an AI software application to aid in the cognitive impairment detection. The companion robot 100 can include an effectual companion chatbot for people with Mild Cognitive Impairment (MCI) using state-of-the-art natural language processing and deep machine learning algorithms. In some embodiments, the companion robot 100 may use chatbot technologies to tailor the companion robot 100 to meet the socio-emotional needs of older adults with cognitive impairments and their caregivers. Given the unprecedented growth in the number of adults with MCI/AD/ADRD there is an urgent need for a suitable chatbot app used in conjunction with the companion robot 100 that is made expressly for older adults with cognitive impairments.

In some embodiments, the companion robot 100 may include a human-like face and voice with facial expressions and may converse and empathize with users through a smart module for detecting emotion. In some embodiments, the companion robot 100 can recognize users' speech through automated speech recognition (ASR), engage users in conversation via a dialogue management system (DMS), and monitor cognitive and language performance over time. In some embodiments, the companion robot 100 may include an easily accessible conversational agent available on smart phones, tablets, or computer systems.

The companion robot 100 may form a Bluetooth connection with a user device for receiving input from a user device such as, for example, playing music, filling a form, playing games, etc. The companion robot 100 send information (e.g., a wellness report) to a user device over the Bluetooth connection. The companion robot 100 may output video and/or audio signals received over a network. For example, the companion robot 100 may include a radio antenna and the companion robot 100 may play music received from a (e.g., user selected) radio station. In some embodiments, the companion robot 100 may play music (or other audio) received through an internet connection from, for example, a music-sharing platform (e.g., SoundCloud). The companion robot 100 may output video and/or audio (e.g., from a video chat) received over the network, and may provide video and/or audio signals from or indicating the patient to a remote device.

The companion robot 100 may include a voice-command interface. For example, a user may provide voice commands to the companion robot 100. The companion robot 100 may detect keywords that may be, for example, reserved as commands. The companion robot 100 may provide available commands (e.g., perform a cognitive health assessment, make a phone call, begin a game, begin an activity, etc.) to the user by, for example, outputting available commands as audio output to the speaker or by presenting available commands to a display (e.g., the tablet).

In some embodiments, the companion robot 100 may interact conversationally with a user and can improve psychological well-being and loneliness in individuals with cognitive impairment. In some embodiments, the companion robot 100 gives a user with MCI the opportunity to engage in dynamic conversation about topics consistent with and targeted for the aging population demographic.

The companion robot 100 can show interest and curiosity in older adults' lives, hobbies, and memories. The companion robot 100 may achieve this by accessing information from past conversation data (e.g., summaries of past conversations with a user) and/or from a personal profile of the user, which may, for example, include personal information associated with the user. The personal profile may be information provided by the user, for example, through manual input from the user or provided to the companion robot 100 during a conversation. The companion robot's 100 personality may be warm and friendly, and may be similar to speaking with a loved one or companion. The conversational design may be intended to uplift the user's mood with a sense of humor to elicit laughter and sentiment analysis to empathize with them—understanding when they are feeling happy, sad, depressed, or neutral—and reacting accordingly.

In some embodiments, the companion robot 100 monitors MCI symptoms by tracking language and cognitive functions. In some embodiments, the companion robot 100 uses AI technologies to increase the speed and accuracy of detecting early signs of impairment and monitoring cognitive decline. NLP is a useful branch of AI to analyze samples of speech in individuals with cognitive impairment. In some embodiments, the companion robot 100 may use advanced AI-based linguistic analyses of spoken words to see if indicators of MCI were present in the speech of older adults, distinguishing cognitively impaired older adults from cognitively intact adults.

In some embodiments, the companion robot 100 uses dialogue analysis to separate MCI from normal cognitive status based on an analysis of questions and answers and can further predict disease progress in a cost-effective alternative to in-person interviews for distinguishing normal aging from MCI. Similarly, the companion robot 100 can test and record MCI individuals' cognitive status using linguistic, acoustic, and prosodic patterns, providing older adults and their caretakers with a cost-efficient way of staying up to date on cognitive changes.

In some embodiments, the companion robot 100 is well-suited for conversational interaction, cognitive analysis, and emotion recognition. In some embodiments, the companion robot 100 uses a combination of computer animation, NLP, speech processing, deep machine learning, and ASR that provide engaging interaction, accurate language, cognitive, and memory monitoring, voice recognition, and dialogue retrieval compared to other virtual assistants on the market. NLP is an effective means of distinguishing between cognitively healthy and impaired individuals.

In some embodiments, the companion robot 100 uses AI-based NLP algorithms to automatically assess language frailty without transcription and detect early cognitive decline. In some embodiments, the companion robot 100 uses machine learning and NLP algorithms to provide the companion robot 100 with responses for thoughtful and engaging high-fidelity conversations with older users through dialogues specifically crafted for the aging population demographic. The deep learning techniques can develop an AI-based dialogue management system (DMS) and automatically query the dialogues to retrieve the best responses for an appealing conversation with older adults experiencing various levels of cognitive decline (e.g., early to late-stage MCI). The chatbot design may incorporate state-of-the-art transformer models for language generation, an intent classifier, and/or entity tracker to monitor high level topic changes from both the user and chatbot, with a response priority decision system. In some embodiments, the developed chatbot is used in the companion robot 100.

In some embodiments, the companion robot 100 is configured to connect with users on topics that are targeted for and interest them and speak in a more warm, lifelike, emotive, and engaging way with a particular emphasis on empathizing with older adult users. The companion robot 100 may determine topics that interest the user based on the current question or topic of the user, or other characteristics of the immediate conversation (e.g., response time or response length or the user), or may determine the topic of interest based on the personal profile associated with the user. Older adults with cognitive impairments may experience increased social isolation as a result of language deficits. In some embodiments, the companion robot 100 can converse with users who may be experiencing language deficits. The companion robot 100 can capture and understand the breadth of users' responses—ranging from more to less complex—and then formulate what it should say next based on the user's response. A user can simply say “yes” or “no” to prompts and still have a meaningful, unique conversation that is tailored toward their interests.

In some embodiments, the companion robot 100 is capable of mirroring the participants' emotions and showing a compassionate face when users express negative emotions. In some embodiments, the companion robot 100 includes an automated AI-based module to monitor users' cognitive health by analyzing the acoustic and language features and detecting digital biomarkers. The companion robot 100 can monitor the socio-emotional well-being of users using speech emotion recognition and sentiment analysis.

The companion robot 100 can ask users directly how they are feeling. For example, self-reporting may be important in case the AI algorithm makes a mistake, or if users do not express emotion through tone of voice, verbal language, or body language. The companion robot 100 can adapt conversations based on the users' sentiment with the objective of improving socio-emotional well-being and mood.

In some embodiments, the chatbot utilizes an automated ML-based algorithm for ranking and retrieval of the most relevant response(s) from a corpus to achieve very high accuracy based on the state-of-the-art similarity assessments in NLP. In some embodiments, an attention mechanism is used and can improve the results in natural language understanding tasks like translation, questions and answers, summarization, and dialogue systems. The attention mechanism is a novel way to model the information in long sentences and use them for generative and classification tasks.

In some embodiments, the chatbot utilizes a generative deep learning model using pretrained language models augmented with the corpus to generate novel responses relevant to MCI participants. This can be done by extracting topics from dialogue datasets and then fusing this domain knowledge with a general language model to create on-topic dialogues with users. Thereafter, a Bayes model may be applied to use this information as a prior probability and the language model as the likelihood to generate a posterior probability that generates conversations on a specified topic. Models are used to increase the chatbot knowledge and make the dialogues satisfactory for users. Using the same topic modeling information, base dialogue models can be used to generate responses on topics of interest.

In some embodiments, the companion robot 100 or ChatBot can use a socio-emotional measurement module to actively empathize with users, meaning responses of the companion robot 100 may be adjusted or selected based on users' moods and feelings. The empathy is achieved by choosing appropriate responses based on context and situation. The responses may help to calm users, tell humorous facts, stories, or jokes, and depending on the situation the companion robot 100 might empathize. Since the companion robot 100 may be capable of expressing different facial expressions, it can smile when users are happy and show a compassionate face when they are unhappy. For example, if a user were to state to the companion robot 100 that “I do not feel well,” or “I did not sleep well last night,” the ChatBot may respond based on this situational context by saying “I am sorry to hear you are having such a tough time.” The ChatBot may then provide additional response and/or assistance for improving the mood, depression assessment, and/or cognitive impairment assessment of the user by, for example, saying “I really care about how you are feeling. Would you like to talk about what is on your mind or perhaps listen to some calming music?” The companion robot 100 may then receive audio input from the user or play music through the speaker based on the a response from the user.

In some embodiments, the companion robot 100 can assess language impairment. Language impairment in individuals with dementia is the result of a decline in semantic and pragmatic levels of language processing. Impairments associated with semantic processing may include difficulties with word finding, naming, word comprehension, semantic paraphasia (choosing incorrect words), empty speech (using ambiguous referents), inventing words, and/or loss of verbal fluency. Impairments associated with pragmatic processing may extend beyond words and their meaning to language adaptation in social situations. Other language impairment changes in MCI and early stages of AD/ADRD involve lexical retrieval problems, loss of verbal fluency, and breakdown in written and spoken language comprehension. MRI & PET scanning and neuropsychic examination are expensive and may prove challenging for early MCI individuals, especially given the brain's structural changes at this point might be harder to detect. Studies have shown that automatic speech and language analysis using machine-learning algorithms can be an effective and useful tool for the detection of dementia as well as cognitive impairment in its early stages. The companion robot 100 may be configured to perform these tasks and analyze language and predict cognitive impairment.

In some embodiments, the companion robot 100 utilizes deep learning models to detect and distinguish the cognitive abilities of people with MCI from normal controls. In some embodiments, the companion robot 100 utilizes a hybrid approach using both language patterns and speech features to assess cognitive changes in older adults. In some embodiments, the companion robot 100 can calculate and record language measures, namely coherence, cohesion, proposition, grammaticality, lexicality, fluency over time. In some embodiments, the companion robot 100 can calculate baseline values for a healthy aging population and people with dementia.

In some embodiments, the companion robot 100 utilizes a trained hybrid language model using datasets that include language pattern and speech signal to determine a level of cognitive impairment. The model can extract speech features and linguistic features.

Language impairments in older adults may be associated with both behavioral and psychological symptoms of dementia, and impairment of expressive language can be associated with delusions and depression tendency. Progressive communication decline in individuals with dementia can trigger other behavioral problems, such as agitation, restlessness, and wandering. Integrating emotion recognition technology in conversation with users has a significant impact on the quality of conversation and improves the well-being of users of the companion robot 100. The companion robot 100 can maintain ongoing communication with the user to bolster spoken language abilities and decrease social isolation, thus improving well-being and elevating mood.

In some embodiments, the companion robot 100 utilizes speech signals to recognize emotions. Automated sentiment analysis has proven to be reliable and promising in measuring user's feeling from texts or transcribed language. The companion robot 100 can use automated sentiment analysis. Sentiment analysis models may classify each sentence into positive, neutral, and negative labels with a value between −1 to +1. The companion robot 100 can detect socio-emotional measures. The socio-emotional measure may refers to a broader assessment of a user's emotional well-being and social engagement over time. For example, the companion robot 100 may detect socio-emotional measures including loneliness, mood, social connectedness, engagement level, emotional responsiveness, and/or conversational reciprocity. These measures may be derived from multiple signals, such as speech, facial expressions, interaction patterns, and standardized assessments.

The socio-emotional measure me differ from a sentiment analysis, which may evaluate the emotional tone of a specific utterance or text segment, such as whether an utterance is positive, negative, or neutral. Sentiment analysis may be an input into a socio-emotional measure determination, but socio-emotional measures may indicate broader, multimodal, and/or often longitudinal parameters or characteristics when compared to a sentiment analysis.

The companion robot 100 may be designed to address users' emotional state by empathizing through conversation. If the algorithm detects anything unusual (e.g., severe changes in the user's mood and feeling) or notices major depression, this may be conveyed to the user and they may be referred to their primary care provider for further evaluation. Similarly, if the algorithm notices a change in the person's cognition and indications of possible ADRD, the user may be informed through a dashboard and may be referred to their primary care provider for further evaluation.

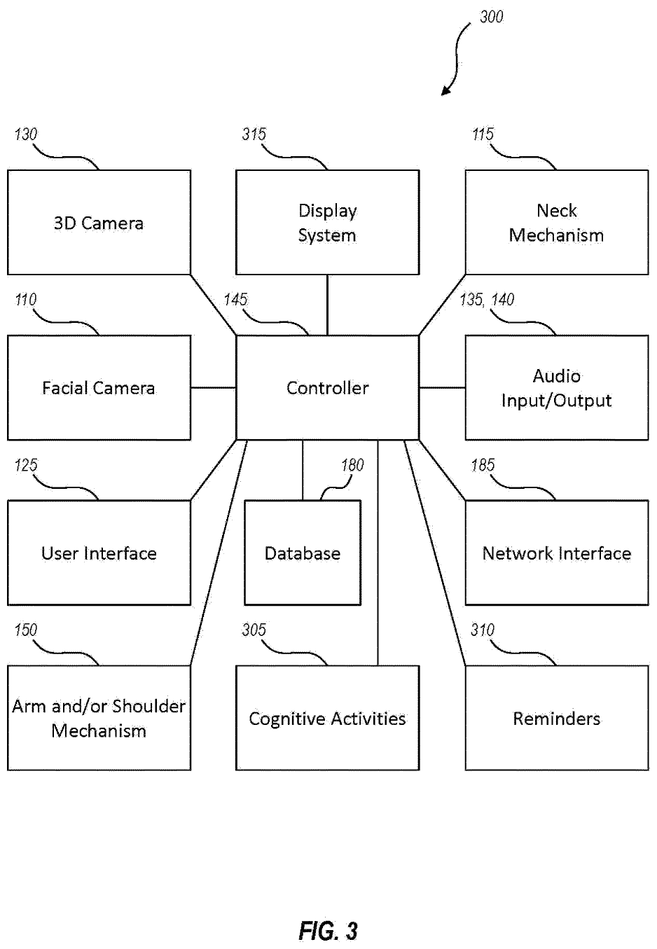

FIG. 3 is a block diagram of various components of a companion robot architecture 300 according to some embodiments. Any component may be added or removed. The companion robot architecture 300 may include the controller 145 that controls the operation of the various components. The controller 145 may include any or all components of computational system 600. The controller 145 may receive inputs from the various components, process the inputs from one or more components based on algorithms, software, routines, etc. and return commands to one or more components.

In some embodiments, the controller 145 may be coupled with the 3D camera 130. The 3D camera 130, for example, may provide data to the controller indicating the location of a user within the field of view of the 3D camera 130. For example, the 3D camera 130 may provide an image file that includes RGB values and range values for various points within the field of view. The controller can perform any number of visual processing functions or algorithms to make determinations about the user and/or the user's environment.

In some embodiments, the controller 145 may determine the activity level of the user based on images from the 3D camera 130. For example, if the controller 145 detects long periods of inactivity, the controller 145 may communicate such inactivity or send an alert to any individual such as, for example, care staff, physicians, family, etc., via the network interface 185. As another example, if the controller 145 detects inactivity during periods of time when activity is typically expected, the controller 145 may communicate such inactivity or an alert via the network interface 185.

In some embodiments, the controller 145 may detect a fall of the user based on images from the 3D camera 130. The controller 145 may detect sudden changes in the position of the user, for example, from a standing position to a prone position (or other position of the user on the floor). The controller 145 may communicate a detected fall by sending an alert to a family member, care staff, or other individual(s).

The controller 145 may detect a fall by performing skeleton extraction on images received from the 3D camera (or other camera). For example, an extract skeleton may be formed based on a plurality of points indicating positions of the body of the user. Skeleton extraction may be performed by a skeleton detection algorithm, such as BlazePose,

A fall status of the user may then be determined based on the extract skeleton. The fall status may include attributes such as “fall,” “near fall” (e.g., indicating high risk of fall), “instability” (e.g., indicating moderate risk of fall), and/or “activity of daily living” (ADL) (e.g., which may indicate little or no risk of fall). In some embodiments, the fall status may be based on a label of the extract skeleton. For example, a fall detection model provided with the extract skeleton may assign a label to the extract skeleton, wherein the label includes a value between 0 and 1 that indicates the risk of a fall of the user. The fall detection model may comprise a machine learning model or other AI program, such as a CTR-GCN activity detection model (e.g., MMaction2 library). The fall status attributes may correspond to ranges within the available values of the label. For example, labels having a value near 0 (e.g., indicating a no or low risk of fall) may be have a fall status of “ADL” while labels having a value near 1 (e.g., indicating a high risk of fall) may have a fall status of “fall” or “near fall.” When a fall is detected (e.g., when the fall status indicates “fall”), the companion robot 100 may send a notification to notify a caregiver that the user has experienced a fall. This may enable a caregiver to receive timely notification of the incidence of a fall and to provide prompt assistance to the user.

A fall risk report may be generated by the companion robot 100 indicating the incidence and/or rate at which the user experiences near-fall or instability scenarios, or which may indicate the frequency at which the user's position/pose indicates each or a subset of the fall status attributes. The fall risk report may be sent to a caregiver, which may be used to determine needed changes in the observation, care, or activity of the user for preventing or reducing the occurrence of future falls.

In some embodiments, the controller 145 may determine the mood of the user based on images from the 3D camera 130. For example, the mood of the user can be determined based, the location of the user, the motion of the user, the body language of the user, etc. In some embodiments, a visual processing algorithm may be used to determine the mood of the user based on the images from the 3D camera.

In some embodiments, the controller 145 may determine the activity level of the user during an exercise event. An application executing on the controller 145 may adjust the intensity of the exercise activity based on the user's activity level. For instance, if the user has low activity, the application may change the exercise.

In some embodiments, the controller 145 may be coupled with the display system 315. The display system 315 may include one or more displays and/or projectors (e.g., projector 107 or LED display). In some embodiments, the controller 145 may select one or more facial expressions from a database of facial expressions (e.g., as stored in database 180), and send the selected facial expression to the display system 315 (e.g., the projector 107 that projects on the facemask 105 or displaying on an LED display). The facial expressions, for example, may be selected based on a mood of the user, which may, for example, be determined from the user's verbal responses, the user's facial expression, the user's speech, and/or the user's body image. In some embodiments, the database of facial expressions may include facial expressions that express the following moods: anger, joy, disgust, surprise, fear, neutral, contempt, compassion, and/or sadness.

In some embodiments, the controller 145 may be coupled with the neck mechanism 115. In some embodiments, the controller 145 may select one or more sequences of neck movements from a database of neck movements (e.g., as stored in database 180), and send the selected sequence of neck movements to the neck mechanism 115 to move the head 190. In some embodiments, the selected sequence of neck movements may be selected based on a mood. The sequence of neck movements, for example, may be selected based on the mood of the user, which may, for example, be determined from the user's verbal responses, the user's facial expression, and/or the user's body image. In some embodiments, the database of neck movements may include neck movements that express the following moods: anger, joy, disgust, surprise, fear, and sadness. For example, the neck movement may be generated to shake the head 190 of the companion robot 100 (e.g., by rotating the head 190 between left-and right-angled positions repeatedly), to nod (e.g., by rotating the head 190 forwards and backwards one or more times), to tilt the head 190 (e.g., by angling the head 190 in a right or left direction, for example, while maintaining the facemask 105 in a forward orientation), for example, to indicate confusion, or to generate another neck movement.

In some embodiments, the controller 145 may be coupled with the facial camera 110. The facial camera 110 may record images of a user's face. Any type of digital camera may be used. In some embodiments, the controller 145 may be coupled with the audio input/output. The audio input may include a microphone 135. The microphone 135 may include a microphone array or a plurality of microphones. A microphone array, for example, may be used to locate the user based on their voice and/or may help distinguish who is talking in a crowded environment. The audio output may include one or more speakers 140. In some embodiments, the controller 145 may receive audio input from the microphone 135 and/or store the audio input into the database 180. Based at least in part on the content of the audio input, the controller can determine an audio output.

For example, using speech recognition, natural language processing, and/or dialogue modeling techniques an audio output may be determined from the audio input. The audio output, for example, may be conversational speech. The audio output, for example, may be an answer in response to a question. The audio output, for example, may be an expression, articulation, recognition, or communication of emotion. In some embodiments, the controller 145 may provide the audio output to the user via the speaker 140.

In some embodiments, the controller 145 may determine a mood of a user. The mood of the user may include anger, anxiety, disgust, dejection, fear, grief, guilt, joy, loneliness, love, sadness, shame, and/or surprise, etc. Any other mood may be determined. The mood, for example, may be determined based on facial images recorded by the facial camera 110, body language of the user recorded by the 3D camera 130, the content of the language and/or the tone of the user received from the microphone 135, and/or the time of day or other historical data. Any techniques known in the art may be used to determine the mood of the user based on these inputs.

In some embodiments, emotion or mood can be measured or determined using a sentiment analysis. A sentiment analysis, for example, can include analyzing the words expressed by a user to determine the emotion or mood of the user. Any type of sentiment analysis tool, algorithm, process, etc. may be used to determine the mood or emotion of a user such as, for example, GATE plugins (e.g., SEAS(gsi-upm/SEAS) or SAGA(gsi-upm/SAGA)), Stanford Sentiment Analysis Module (e.g., Deeply Moving: Deep Learning for Sentiment Analysis), LingPipe (e.g., Sentiment Analysis Tutorial, TextBlob (e.g., Tutorial: Quickstart), Opinion Finder (e.g., OpinionFinder|MPQA), Clips pattern. en (e.g., pattern.en|CLiPS), SentiWordNet, Bing Liu Datasets (Opinion Mining, Sentiment Analysis, Opinion Extraction), General Inquirer Dataset (e.g., General Inquirer Categories), MPQA Opinion Corpus (e.g., MPQA Resources), WordNet-Affect (e.g., WordNet Domains), SenticNet, Emoji Sentiment Ranking, etc.

In some embodiments, the companion robot 100 may express a mood by moving the head, projecting a facial image, and/or outputting speech based on the mood. For example, the controller 145 may select a sequence of neck movements corresponding to a mood, and the neck mechanism 115 may move the head in response to the sequence of neck movements. As another example, the controller 145 may select a facial image corresponding to a mood, and the projection projector 107 may project the facial image on the facemask 105 (or display the facial images on an LED display). As another example, the controller 145 may select a voice tone or words, phrases, or sentences based on a mood to the user via the speakers.

In some embodiments, the controller 145 may be coupled with the user interface 125. The controller 145 may receive user input via the user interface. In some embodiments, the controller 145 may be coupled with a database 180. The database 180, for example, may include data relating a plurality of specific moods with a sequence of neck movements, a facial expression, a speech tone, or language. When a mood has been determined, a corresponding neck movement, an arm gesture, a facial expression, speech tone, or language may be selected from the database based on the mood.

In some embodiments, the database 180 may include a set of 3D modules that include a number of facial expressions. For example, the database 180 may include a plurality of polygons that define a face with facial expressions. The database 180 may also include a plurality of blend shapes (e.g., upper eye shapes and lower mouth shapes, etc.).

In some embodiments, the database 180 may include a plurality of different facial models (e.g., of a female, a male, an Asian, a Caucasian, a Hispanic, a Middle Eastern, an African, a Polynesian, an Indian, etc. face). These facial models may offer users a choice of appearances that may be more appealing to a specific user and can be changed based on user input or based on images received by the facial camera 110. In some embodiments, the facial models may include facial blend shapes (e.g., upper eye shapes and lower mouth shapes). In some embodiments, the facial models may animate between multiple shapes at a time. In some embodiments, these facial models may be generated with a character generation tool kit (e.g. Mixamo's Fuse), or a facial animation system created by Unity 3D. In some embodiments, the facial models can be combined to create a wide variety of facial expressions and/or visemes. In some embodiments, the facial models may co-articulate animations between different muscle groups in the face, creating a more life-like appearance of utterances and lip sync.

In some embodiments, the database 180 may include a plurality of different language models to enable the companion robot 100 to speak with a user in a variety of languages, such as, for example, a user's native language. For example, the database 180 may include language models to speaking in English, Spanish, Portuguese, French, Italian, Japanese, Mandarin, German, Russian, and/or Hindi to provide multilingual support. The database 180 may include language models for male and female voices, for example, in each language. The language and sex of the companion robot's 100 voice may be selectable by the user.

In some embodiments, the controller may include (or may be part of a separate image processor) a 3D Game Engine (e.g., Unity 3D) that can edit, process, and/or produce .anim files of a face that can then be output as a movie or image file that is projected onto the facemask by the projector.

In some embodiments, the database 180 may include user preferences, user expressions, user data, etc. that can be used by the controller to process user inputs (e.g., facial expressions, speech, etc.) and produce outputs (e.g., speech content, facial expressions, neck mechanism movements, etc.) that are related to a specific user. In some embodiments, the database may include specific user profiles consisting of user preferences, a history of interactions, a history of user moods, a history of user responses to robot actions or words, etc. that can be loaded upon facial recognition of the user or selection of the user's profile from the user interface.

In some embodiments, the database 180 may include relationships between facial expression data and user moods and/or behaviors. The controller 145 may compare facial expression data with a relationship table in the database 180 that relates facial expression data with moods to return the mood of a user. In some embodiments, the facial expression data in the table may be user specific.

In some embodiments, the database 180 may include relationships between speech data (e.g., semantic data) and user moods. The controller 145 may compare speech data with a relationship table in the database 180 that relates speech data with moods to return the mood of a user. In some embodiments, the speech data in the table may be user specific.

In some embodiments, the controller 145 may be coupled with a network interface 185. The network interface 185 may include a wired or wireless router. In some embodiments, audio input or filtered and/or modified audio input may be communicated over a network to a speech recognition and/or natural language processing server. An audio response, a mood, and/or text may be returned. In some embodiments, any of the process or methods described within this document may be performed at a remote server that can be communicated with via the network interface 185.

In some embodiments, the controller 145 may be coupled with the arms and shoulders mechanisms 150. The controller 145 may control the motion and/or actions of the arms 175 and/or shoulders via the arms and shoulders mechanisms 150. In some embodiments, the controller 145 may select one or more sequences of arm and/or neck movements from a database of arm and/or neck movements (e.g., as stored in database 180), and send the selected sequence of arm and/or shoulder movements to the arms and shoulders mechanisms 150 to move the arms 175 and/or shoulders. In some embodiments, the selected sequence of arm and/or shoulder movements may be selected based on a mood. The sequence of arm and/or shoulder movements, for example, may be selected based on the mood of the user, which may, for example, be determined from the user's verbal responses, the user's facial expression, and/or the user's body image. In some embodiments, the database of arm and/or shoulder movements may include arm and/or shoulder movements that express the following moods: anger, joy, disgust, surprise, fear, and sadness.

The arm and/or shoulder movements may be generated to produce a gesture for expressing ideas, emotions, and/or intentions. The arms and/or shoulders mechanisms 150 may enable a variety of gestures. In some embodiments, the arms and/or shoulders mechanisms 150 may enable the companion robot 100 to perform any gesture that may be typically performed by a human adult. For example, the companion robot 100 may perform a beckoning gesture (e.g., the elbow flexing to bring the hand of the companion robot 100 towards the torso), a celebration gesture (e.g., by flexing the shoulders to raise both hands above the head 190 of the companion robot 100), a thinking gesture (e.g., by flexing the shoulders and flexing and rotating the elbow to bring the hand to the chin of the companion robot 100), or other gesture.

The speech and audio output and the facial image projection of the companion robot 100 may be synchronized with physical movement from, for example, the neck mechanism 115, the arms and shoulders mechanism 150, and/or the wheels 144 to form a synchronized response. That is a synchronized response may include audio output as well as a facial image projection, neck movements, arm and/or shoulder movements, and/or wheel movement that is generated to sync and/or accompany the audio output to form a unified expression, pose, interaction, or reaction. The synchronized response may be generated by combining separate actions or movements that may be performed independently by the speaker 140, the projector or other display, the neck mechanism 115, the arms and/or shoulders mechanism 150, and/or the wheels 144. The synchronized response may be generated based on the mood, depression assessment, and/or cognitive impairment assessment of the user.

The following are a few examples of synchronized responses. A synchronized response including a greeting may be generated by outputting audio including an audio greeting (e.g., audio output saying “hello”), producing a warm, surprised, and/or inviting facial image on the facemask 105 (e.g., a smile), and generating a waving gesture in an arm 175 via the arms and/or shoulders mechanism 150. A synchronized response including a celebratory response may be generated by outputting audio to express joy, delight, or triumph (e.g., speech output saying “hurray!”), producing an excited and/or happy facial image on the facemask 105, and raising both arms 175 in celebration. In another example, a synchronized response including a thinking response may be generated by outputting audio to express processing of information or contemplation (e.g., speech output saying “let me think about that . . . ”), while generating a pensive facial image on the facemask 105 (e.g., a facial image exhibiting pursed lips and furrowed eyebrows), and generating a pensive gesture by bringing the hand of the companion robot 100 to the chin of the facemask 105 in an expression of thoughtfulness. In a last example, a synchronized response including an agreement response may be generated by outputting audio to express concurrence, sympathy, and/or rapport (e.g., speech output saying “that's right,” “correct!,” “I agree,” or “I understand . . . ”), generating a sympathetic facial image on the facemask 105, and producing an agreeing gesture, such as a head nod and/or a pointing gesture (e.g., including rotation of the elbow using the arms and shoulders mechanism 150 to shake and/or position the hand of the companion robot 100)

In some embodiments, the controller may also provide one or more cognitive activities to a user, for example, via block 305. These cognitive activities may be provided to the user in conjunction with one or more other blocks such as, for example, via user interface 125, audio input/output, display system 315, etc. The cognitive activities may include cognitive games, quizzes, questions and answers, displaying images, displaying images of the user's family and/or past, directing the user in exercises, displaying music, etc. In some embodiments, the cognitive activities at block 305 may be provided in response to the mood of the user.

In some embodiments, the controller may also provide reminders to a user, for example, via block 310. These reminders may be provided to the user in conjunction with one or more other blocks such as, for example, via user interface 125, audio input/output, display system 315, etc. The reminders may include reminders to take medication, reminders to attend an appointment, reminders to perform an activity, reminders to attend to personal hygiene, etc. In some embodiments, the reminders at block 310 may be provided in response to the mood of the user. In some embodiments, these reminders may be visual and/or audio reminders.

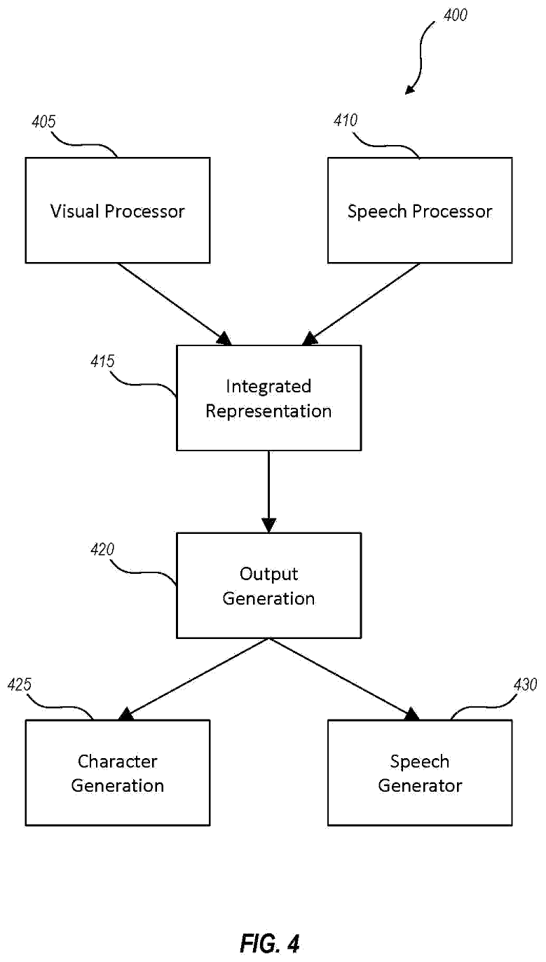

FIG. 4 is a block diagram 400 illustrating a plurality of processing modules of the controller 145. The various modules may be implemented either in software and/or in hardware. Other processing modules may be included. One or more of the modules may be removed.

In some embodiments, an audio input received from the microphone 135 may be processed via the speech processor. The speech processor may perform a number of activities. The speech processor, for example, may filter out non-speech sounds such as background noise until speech is detected. When speech is detected, for example, the speech may be decoded into word strings. An emotion classifier may attach emotions to the strings based on the language content of the speech and/or based on the acoustic properties of the speech (e.g., tone). The speech may then be semantically parsed producing a semantic representation of the speech. The semantic representation of the speech may be stored in the database 180 along with speech emotion tags (or markers). The speech emotion tags may be saved in the dataset 180. The speech emotion tags may include the emotions of anger, anxiety, disgust, dejection, fear, grief, guilt, joy, loneliness, love, sadness, shame, and/or surprise, etc.

In some embodiments, the speech processor may produce a semantic representation of the user's speech using a dialogue manager such as, for example, a Phoenix parser. Speech, for example, may be mapped onto a sequence of semantic frames (e.g., task frames). This representation may be considered a shallow semantic representation that represents the entities, events and relations between them. Grammars, for example, may be used to match word strings against patterns for the frame elements. These may be considered Context Free patterns where the non-terminals are concepts, events, and/or relations that may be important in the domain. The grammar rules, for example, may be written manually or trained from an annotated database. In some embodiments, the extracted frame information may be augmented by the speech-based emotion classification, vision-based emotion classification, face tracking, and/or gaze detection features to create the extracted representation of the last utterance.

As another example, a dialogue manager may use a task file that determines how the companion robot 100 may interact with a user in response to the user's speech and affect (e.g., engagement, frustration, excitement, tone, facial expression, etc.). In some embodiments, the task file may include definitions of the task frames to be used by the application. A task frame may include a data object that contains the information necessary to interact about the frame, these may include, for example: a) Frame Elements—the extracted information (e.g., speech and/or affect); b) Templates for generating responses from items in the context based on the extracted information; and/or c) Pattern-Action pairs, called rules, for generating responses, which may include word strings, neck movement sequences, and/or facial expressions. In some embodiments, a dialogue manager may interpret a user's facial expressions, eye gaze, and/or speech prosody to convey affect and/or produce corresponding facial expressions, eye gaze, and/or speech prosody. For example, when the user is speaking, the companion robot can smile and nod to indicate it understands or agrees with what the user is saying. As another example, the head may be moved by neck mechanisms to produce head nods or rotation of the head while listening or thinking, which may be synchronized with spoken utterances and the location of the user in space.

In some embodiments, the visual processor may receive video input from either or both the 3D camera 130 and/or the facial camera 110. The visual processor may perform facial detection, facial tracking, and/or gaze detection, etc. The visual processor may also classify the emotion of the user based on features extracted from the facial image. These emotions may be stored in the database 180. In some embodiments, the database 180 may also include facial tracking data and/or gaze detection data. The visual processor may also tag the images and/or video with vision emotion tags (or markers) based on emotions expressed by facial expressions, gaze detection, body language, etc. The emotion tags may represent the mood of the user. The vision emotion tags may be saved in the database 180. The vision emotion tags may include the emotions of anger, anxiety, disgust, dejection, fear, grief, guilt, joy, loneliness, love, sadness, shame, and/or surprise, etc.

In some embodiments, convolutional neural networks and/or deep residual networks may be used to recognize facial expressions from the video input. The idea behind residual connections is that the forward and backward signals can be directly propagated from one block to any other block with an identity mapping as the skip connections. The identity mapping in these networks may, for example, achieve fast error reduction and low training loss during the training phase, yet having lower complexity compared with a shallower network without identity mapping. In some embodiments, several residual units with different filter sizes and number of channels may be stacked and a 32-layer residual network can be trained for a facial expression module. The network can be trained on 400,000 human labeled facial expression images of the AffectNet database. The training samples, for example, may cover unconstrained facial expressions captured from the Internet by querying different search. Hence, the network may be able to recognize facial expressions in an uncontrolled environment (i.e., a wild setting) where the scene lighting, camera view, image resolution, background, users head pose, gender, and ethnicity can vary significantly.

In some embodiments, data from the visual processor and/or the speech processor may be processed by the integrated representation module. The integrated representation module may integrate the speech portion of the audio input and the video input. In some embodiments, the integrated representation module may combine the speech emotion tags with the vision emotion tags to create an integrated emotion (or mood). The integrated emotion may include the emotions of anger, anxiety, disgust, dejection, fear, grief, guilt, joy, loneliness, love, sadness, shame, and/or surprise, etc.

At block 420, an output may be generated based on the integrated emotion (or mood). The output may include, for example, an audio speech response and/or a visual response. For example, at block 420 semantic output and/or emotional output can be determined. The semantic output, for example, may include words, phrases, and/or sentences. The emotional output, for example, can include anger, anxiety, disgust, dejection, fear, grief, guilt, joy, loneliness, love, sadness, shame, and/or surprise, etc.

The output, for example, may be generated using machine learning algorithms that recognize affect through facial expression recognition and/or the parsing of spoken utterances for emotional content. The facial expression of a user may be identified as action units, for example, defined by the Facial Action Coding System (FACS). In some embodiments, the output can include a description of possible and/or visually detectable facial variations in terms of muscle-based action units. Facial expressions including the six basic/universal expressions can be modeled by a single action unit or combination of action units.

In some embodiments, block 420 may include a dialogue management system that can be used to provide dialogue with a user based on the user input. In some embodiments, a cloud-based dialogue management system may be used. In some embodiments, a stand-alone chatbot system (e.g., Program-Y or Program-R or the like) or a web service for building and deploying a ChatBot (e.g. Pandorabot) may be used. For example, a transcript of the audio input may be provided to the ChatBot to generate dialogue for use in a conversation with the user. Some ChatBots may be built using the open source Artificial Intelligence Markup Language (AIML) framework. In an example, a ChatBot may be developed by either Mitsuku or Chomsky. Any type of ChatBox may be used such as, for example, a custom made ChatBox. The Chatbox may be focused on questions and answers that are designed for people with Alzheimer's disease, depression, or any other illness.

In some embodiments, ChatBots may be user friendly. In some embodiments, a ChatBot can answer users' questions, tell them jokes, empathize with users, and have conversations about a number of subjects using AIML dialogue scripts written for them. The ChatBot may answer a user's questions if the subject and answers are defined in the AIML scripts. If not, the ChatBot might say “I do not know the answer” or “I wish I knew the answer” and may be taught the correct response.

The ChatBot may comprise a small language model (SLM) and a large language model (LLM) for generating dialogue during conversation with the user. This may enable the companion robot 100 to reduce the amount of latency required to respond to the user during conversation and which may be used to inform the user that the companion robot 100 is processing, for example, in response to an asked question or request or to generate dialogue with the user. The SLM may be used to quickly generate a response while the LLM is generating dialogue. For example, when the user asks the companion robot 100 a question, the SML may generate or retrieve (e.g., from the stored AIML dialogue scripts) a short response. The short response may be a verbal pause (e.g., thinking pauses or transitional pauses), such as “let me think about that,” “that is interesting . . . ,” “hmm . . . ,” or “so . . . ,” that indicate the companion robot 100 is processing (i.e., thinking) via the (e.g., higher-latency) LLM to generate a response.

The ChatBot can also be customized according to the needs and/or desires of the user. For example, the ChatBot may include a (e.g., preset or preprogrammed) personality. The personality of the ChatBot may be a setting or configuration of the ChatBot that biases the dialogue generation of the ChatBot to one or more topics, styles, moods, orientations, or emphases. The personality may be manually selected by the user, for example, through the touchscreen, through a voice command, or through a login credential (e.g., a user identification card). In some embodiments, the personality may be selected by the companion robot 100, for example, based on facial or voice recognition, or based on one or more parameters. The selected personality may be based on the mood, depression assessment, and/or cognitive impairment assessment of the user, and may be selected, for example, to improve the mood, alleviate and/or mitigate the depression, or to strengthen or exercise the cognition of the user. In some embodiments, the personality may be selected by the companion robot 100, for example, based on one or more parameters. For example, the companion robot 100 may (e.g., periodically and/or randomly) select different personalities of the ChatBot for generating dialogue with the user, for example, during a personality test. During the personality test, the different personalities may be selected at intervals such as between conversations or interactions, or between days, weeks, or other time intervals. The companion robot 100 may record and/or store measured parameters while using the particular personalities, including parameters such as mood, cognitive impairment, engagement (e.g., measured through response length of the user), activity level, or other parameters. After the personality test is completed, the companion robot 100 may then select a personality of the ChatBot based on one or more of the measured parameters. The personality may be selected to optimize, maximize, or improve one or more of the measured parameters. For example, the personality may be selected as the personality with the highest likelihood to improve the mood of the user.

The ChatBot may include a variety of personalities. For example, the personalities may include a comedic personality that tends to telling jokes and improving the emotional experience of a user; an academic personality that tends to encourage learning and exploration; a military veteran personality tending to recite (e.g., American) history, provide therapy for ameliorating symptoms of post-traumatic stress disorder (PTSD), or talk about anything (e.g., including sensitive issues with care); a Christian personality (or other religious personality) for supporting religious views or reciting religious texts (e.g.; Bible verses); a high energy personality that exhibits enthusiasm and positivity; and/or a stoic personality for a more reserved and steady comportment and exhibiting careful listening (e.g.; by reciting reflective responses; verbal affirmation; and/or knowledge from past conversations). The ChatBot personalities may also include a default personality which may be pre-selected and which may be the personality of the ChatBot before the user or the companion robot 100 selects a different personality. The default personality may exhibit a warm, optimistic outlook on life and may exhibit genuine interest in information the user has to share.

The ChatBot personality may be further refined or tailored through interaction with the user by, for example, remembering (e.g., storing and retrieving) personal information provided by the users talking to them (e.g., as stored in the database 180). The ChatBot may be configurable, for example, by the user. The ChatBot may be customized to the user, such that the ChatBot may take on a distinct personality for each distinct person or group of persons with which it interacts. In some embodiments, summaries of past conversations with the user may be stored (e.g., within the local database). The personality may be based on the summaries. For example, the summaries from past conversation data may be analyzed for content and the companion robot 100 may select a personality by determining which personality may best interact with the user based on the content of the summaries. The personality may be (e.g., additionally) based on personal information of the user, such as the name, age, and/or favorite music of the user, or based on family information (e.g., names of children of the user) to generate more personalized responses over time. The ChatBot may store a plurality of profiles containing information associated with the distinct personality, such that when a distinct person or group of persons is identified the ChatBot may take on the personality that is associated with the distinct person or group of persons. The personality may be structured or customized to the personality of the user or to improve the emotional and/or cognitive health of the user. For example, the ChatBot may take on an encouraging and optimistic persona when interacting with users suffering from depression, so as to help alleviate that depression.

In some embodiments, the dialogue management system can have dialogue with users about a plurality of different topics including sports, history, games, places, locations, jokes, and/or greetings, etc. In some embodiments, the dialogue management system can also connect to Wikipedia (or any other online database such as www.answers.com) and answer user's questions if it cannot be found in the existing AIML files. In some embodiments, the dialogue management system can be based on large language models such as ChatGPT or Gemini for conversation with users.

At block 425 the character of the companion robot 100 can be determined based on the emotional output. The character of the companion robot 100 can refer to the visual appearance (e.g., including patterns of mechanical movements and/or images and/or animations projected to the facemask or touchscreen display) communicated by the companion robot 100 and/or presented to a user. A sequence of neck movements, for example, can be selected from the database 180 based on the emotional output. One or more facial expressions, for example, can be selected from the database 180 based on the emotional output. One or more visual speech actions, for example, can be selected from the database 180 based on the emotional output. These visual speech actions, for example, can include movement of the lips, tongue and/or jaw that corresponds with the semantic output. One or more arm or shoulder movements, for example, can be selected from the database 180 based on the emotional output.

In some embodiments, Mixamo's Fuse may be used at block 425 to determine visual speech actions that may be output via the projector on to the facemask. Mixamo's Fuse is a character generation toolkit that offers a base mesh of 10,000+ polygonal faces and/or a base library of 50 blend shapes (additional custom and corrective shapes may be modeled in Maya) that can be combined to create a wide variety of facial expressions and visemes. Using the “Shape-Key” facial animation technique, for example, each facial rig can have the opportunity to co-articulate animations between different muscle groups in the face, creating a more life-like appearance of utterances and lip sync.

At block 430 speech output may be generated based on the semantic content. For example, the speech output may include an audio signal that can be sent to the speakers. The speech output can be generated using any type of text to speech process known in the art.

The following is an example interaction between a companion robot and a user. The user may interact with the companion robot by smiling and stating, “Good Morning.” The microphone 135 may receive the user's voice. At block 410, the audio input signal may be processed and/or filtered to isolate the speech elements. The speech may be parsed to detect emotions and a semantic content of the speech may be determined and speech emotion tags may be created. This may be done based on the nature of the language and/or the tone of the voice. Speech emotion tags may be associated with the audio input. In this example, a happy speech emotion tag may be applied.

At block 405 the facial camera 110 may record images of the user while smiling. The smile may be detected. A vision emotion tag may be created and/or associated with the recorded images and/or timestamped. In this example, a happy vision emotional tag may be applied based at least in part on the user's smile.

At block 415 an integrated output may be created. In this example, because both the vision emotion tag and the speech emotion tag are both happy, the integrated output may also be happy.

At block 420 an output may be generated. This output may include speech, such as, for example, “Good morning to you too,” and a happy character expression (e.g., a character expression conveying a happy mood).

At block 425, audio speech may be created representing the phrase “Good morning to you too.” At block 430, neck movements related to happiness and/or facial features related to happiness may be generated (e.g., a smile). At some point the speech, neck movements, body gesture, and/or facial features may be output via speakers, neck mechanisms, arms and/or shoulders, and/or projectors, respectively.

In some embodiments, the companion robot may engage with a user by performing a number of activities. These may include, for example, Montessori-Based activities, serious brain games, cognitive games, dementia therapy activities, memory treatment activities, spaced retrieval activities, etc.

In some embodiments, a similar process as that shown in FIG. 4 can be used for robot-based cognitive behavior therapy (rCBT). For instance, the output generation can include questions or statements from an rCBT engine. These questions or statements may be output via the speaker 140 or touchscreen. User responses can be received through the microphone or the touchscreen.

In some embodiments, the companion robot 100 may comprise an AI agent. The AI agent can comprise a functional orchestration layer that acts as a central coordinator, automating and organizing workflows across disparate systems, applications, data sources, and/or services (e.g., of the companion robot 100). It may represent the autonomous control loop that allows the companion robot 100 to plan multi-step tasks, use external tools, and to self-correct autonomous behavior. The AI agent can interface between user-facing applications (and behavior) and the backend infrastructure of the companion robot 100. The agentive architecture of the AI agent may enable the companion robot 100 to autonomously decide how to achieve a goal based on the user's state (e.g., the mood of the user, or the depression assessment or cognitive impairment assessment of the user). The AI agent may implement a continuous sense-decide-act-evaluate control loop, allowing the companion robot 100 to dynamically adjust its behavior based on ongoing interaction with the user and changes in the user's mental, emotional, or cognitive state. In this manner, the response of the companion robot 100 may be further based on the output of from the AI agent, for example, as the companion robot 100 performs action as part of a sequence of actions or behavior.

In some embodiments, the AI agent is configured to receive or derive one or more interaction goals, such as improving user mood, maintaining cognitive engagement, administering rCBT content, monitoring cognitive decline, encouraging physical activity, or escalating caregiver notifications. The AI agent can decompose a high-level goal into a sequence of subtasks comprising conversational actions, assessments, expressive behaviors, physical movements, or content delivery. The AI agent may execute a multi-step plan to achieve the goal while adapting the plan in real time based on user responses. For example, the AI agent may reprioritize, suspend, or terminate tasks when the user's detected mood, engagement level, fatigue, or cognitive performance changes.

The AI agent may autonomously decide how and when to pursue a goal based on an inferred user state. For example, when elevated depressive symptoms are inferred, the AI agent may elect to defer cognitively demanding tasks and instead initiate empathetic dialogue and mood-regulating activities. Conversely, when engagement is high, the agent may introduce more cognitively stimulating interactions or therapeutic exercises.

The AI agent may select which tool to use, in what order, and with what parameters based on the interaction context and task objective. The AI agent may be implemented using one or more of rule based decision logic, probabilistic models, machine learning based planners, large language model driven reasoning components, and/or hybrid architectures combining any of the above. The agentive architecture may operate entirely on device, partially on device with cloud assistance, or in a distributed manner.

FIG. 5 is a sideview of a robot head 190 according to some embodiments. The head 190 may include a projection system disposed within the head 190. A projector 505 (e.g., a laser projector) may be disposed near the base of the neck at the bottom of the head 190. Images may be projected through a wide angle lens 515 onto a mirror that then reflects the images onto the backside of the facemask 105. Alternatively, an LED display may be used to display facial images.

The computational system 600, shown in FIG. 6 can be used to perform any of the embodiments of this disclosure may. For example, computational system 600 can be used to execute the various process and/or methods described in this document. As another example, computational system 600 can be used perform any calculation, identification and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics processing units (GPUs), graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625 (e.g., one or more computer-readable media), which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of this disclosure may, and/or may be designed to implement methods of this disclosure may and/or configure systems of this disclosure may, as described herein. For example, one or more procedures described with respect to the method(s) discussed above might be implemented as code and/or instructions executable by a computer (and/or a processor within a computer). A set of these instructions and/or codes might be stored on one or more computer-readable storage media, such as the storage device(s) 625 described above, which when executed may cause the processor(s) 610 to execute the methods described herein.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

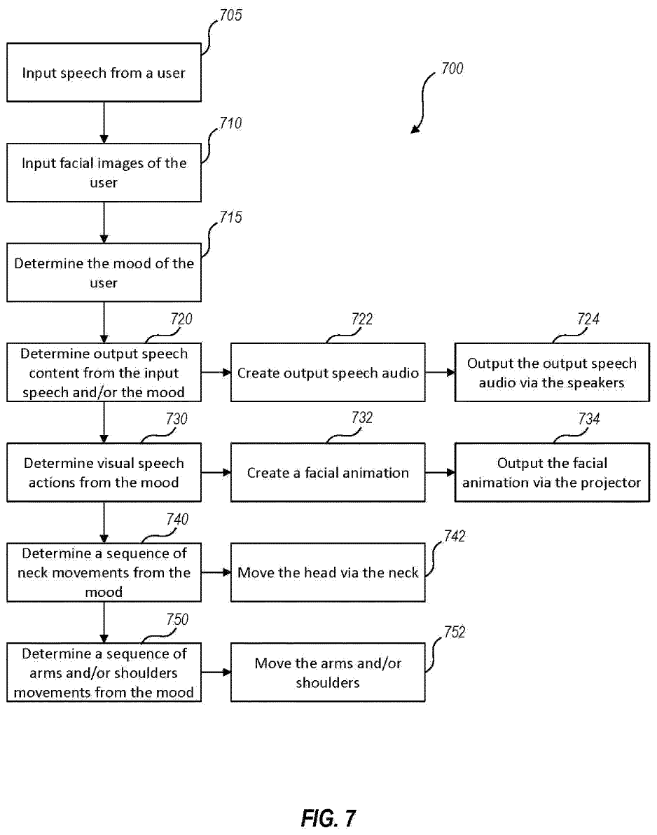

FIG. 7 is a flowchart of a process 700 for controlling the speech and/or affect of a companion robot (e.g., companion robot 100) according to some embodiments. Various additional blocks may be added to process 700. In addition, any number of block may be removed, replaced and/or modified. In some embodiments, process 700 can be executed by controller 145.

Process 700 begins at block 705. At block 705, speech from a user can be input. The speech can be input, for example, via a microphone (e.g., microphone 135) and/or processed to filter out non-speech noise. The speech, for example, may be translated from audio to text.

At block 710 one or more facial images of the user may be input. The one or more facial images may be input from a camera (e.g., facial camera 110).

At block 715 the mood of the user may be determined from either or both the speech and the facial images. Various factors of the facial images can be analyzed to determine the mood of the user such as, for example, the motion and/or position of the eyebrows, the shape of the mouth, the eye gaze, the angle of the head, the tone of the speech, activity, and/or the speech prosody. A database can be used to translate the facial features into a mood.

The speech, for example, can be catalogued and/or processed to produce the semantic forms of the speech that can be used to determine the mood. A database can be used to translate the semantic forms into a mood. The mood, for example, may include anger, anxiety, disgust, dejection, fear, grief, guilt, joy, loneliness, love, sadness, shame, and/or surprise.

At block 720 output speech content may be determined from the input speech (e.g., from block 705) and/or the mood. The output speech content may reflect a response to the user and/or a reaction to the user. The content may vary depending on the speech from the user and/or the user's mood. At block 722 output speech may be created that may include a string of words or phrases or sentences. The output speech may be created, for example, using any type of chatbot. At block 724, the output speech is projected from the speakers.

At block 730 visual speech actions may be determined based on the mood and/or the output speech. Visual speech actions, for example, can include movement of the lips, tongue and/or jaw that corresponds with the semantic output. The visual speech actions can be created by referencing a database indicating various visual actions based on the mood and/or the words or portions of words. At block 732, a facial animation can be created that is projected onto the facemask at block 734. In some embodiments, blocks 734 and 724 may be timed to output at the same time to ensure the output speech audio and the visual actions are aligned.

At block 740 a sequence of neck movements may be determined based on the mood. The sequence of neck movements can be created by referencing a database indicating neck movements based on the mood. At block 742 the neck mechanisms can be activated to move the head according to the sequence of neck movements.

At block 750 a sequence of arm and/or shoulder movements may be determined based on the mood. The sequence of arm and/or shoulder movements can be created by referencing a database indicating arm and/or shoulder movements based on the mood. At block 752 the arms and/or shoulders can be activated to move the arms and/or shoulders according to the sequence of arm and/or shoulder movements.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A companion robot comprising:
a head comprising:
a facemask; and
a projector for projecting facial images onto the facemask;
a facial camera for receiving video signals from an environment;
a microphone for receiving audio signals from the environment;
a speaker for outputting audio signals;
a processor electrically coupled with the projector, the facial camera, the microphone, and the speaker; and
one or more computer-readable media having stored thereon instructions that, when executed, cause the processor to:
receive audio input through the microphone, wherein the audio input comprises speech from a user;
identify speech patterns and linguistic characteristics within the audio input;
determine a user depression assessment based on the speech patterns and linguistic characteristics, wherein the user depression assessment measures a severity level of depression in a user;
generate a response based on the user depression assessment, wherein the response comprises text for alleviating depression of the user; and
deliver the response as speech output through the speaker to the user.

2. The companion robot of claim 1, wherein the instructions further cause the processor to:
receive video input through the facial camera, wherein the video input indicates a face of a user;
identify a facial expression of the user based on the face of the user;
wherein determination of the user depression assessment is further based on the facial expression of the user.

3. The companion robot of claim 2, wherein the instructions further cause the processor to:
determine an emotional state of the user based on the speech patterns and linguistic characteristics of the audio input and the facial expression of the user;
wherein determination of the user depression assessment is further based on the emotional state of the user;
wherein the response comprises text and facial images for improving the emotional state of the user; and
deliver the response as speech output through the speaker and a facial image projected to the facemask.

4. The companion robot of claim 1, wherein the instructions further comprise providing a transcription of the audio input to a ChatBot of the companion robot, and wherein the response is generated by the ChatBot.

5. The companion robot of claim 4, wherein the ChatBot comprises a plurality of personalities, and wherein a personality of the plurality of personalities is selected based on a mood of the user.

6. The companion robot of claim 4, wherein a personality of the ChatBot is further based on summaries of past conversation data generated during conversation with the user.

7. The companion robot of claim 1, wherein the speech patterns and linguistic characteristics are identified by providing the audio input to a natural language processing (NLP) algorithm.

8. The companion robot of claim 1, wherein the instructions further cause the processor to use a large language model dialogue management system to produce interaction between the companion robot and a user.

9. A companion robot comprising:
a head comprising a facial display for communicating facial images to a user;
a neck mechanism mechanically coupled with the head;
a facial camera for receiving video signals from an environment;
a microphone for receiving audio signals from the environment;
a speaker for outputting audio signals;
a processor electrically coupled with the facial display, the facial camera, the neck mechanism, and the microphone; and
one or more computer-readable media having stored thereon instructions that, when executed, cause the processor to:
receive audio input through the microphone, wherein the audio input comprises speech from the user;
provide the audio input to an AI software application, wherein the AI software application analyzes speech patterns and linguistic characteristics within the audio input to perform a cognitive impairment assessment, wherein the cognitive impairment assessment indicates a level of cognitive health of the user;
generate a response based on the cognitive impairment assessment, wherein the response comprises text for mitigating cognitive decline of the user; and
deliver the response as speech output through the speaker to the user.

10. The companion robot of claim 9, wherein the instructions further cause the processor to utilize the AI software application to analyze a set of spoken words from the user to identify an indicator of mild cognitive impairment.

11. The companion robot of claim 9, wherein the processor is further configured to utilize an AI-based NLP algorithm to automatically assess language frailty in the speech patterns and linguistic characteristics.

12. The companion robot of claim 9, wherein the response further comprises a facial image for mitigating cognitive decline of the user, and wherein the instructions further cause the processor to output the facial image to the facial display.

13. The companion robot of claim 12, wherein the facial image is selected to sync with the speech output.

14. The companion robot of claim 9, further comprising a 3D camera in communication with the processor, and wherein the instructions further cause the processor to:
receive 3D images from the 3D camera, wherein the 3D images include a plurality of pixels representing a visual environment and range data;
detect acoustic patterns, language features, and digital biomarkers within the 3D images and the audio input; and
monitor the cognitive health of the user based on the acoustic patterns, language features, and digital biomarkers.

15. The companion robot of claim 14, wherein the instructions further cause the processor to detect a pose of the user and to assign a fall status of the user, wherein the fall status is one of “fall,” “near-fall,” “instability,” or “activity of daily living” (ADL).

16. The companion robot of claim 15, wherein the instructions further cause the processor to notify a caregiver when a fall of the user is detected.

17. The companion robot of claim 9, wherein the instructions further cause the processor to communicate the cognitive impairment assessment to a caregiver.

18. The companion robot of claim 9, wherein the response is further based on output from an AI agent of the companion robot, and wherein the AI agent organizes and coordinates multi-step tasks for engaging with the user.

19. A companion robot comprising:
a head comprising:
a facemask; and
a projector for projecting facial images onto the facemask for communicating facial images to a user;
a neck mechanism mechanically coupling the head with a torso;
a pair of arms and shoulders mechanisms each coupling an arm to the torso for generating arm movements;
a facial camera for receiving video signals from an environment;
a microphone for receiving audio signals from the environment;
a speaker for outputting audio signals;
a processor electrically coupled with the projector, the facial camera, the neck mechanism, and the microphone; and
one or more computer-readable media having stored thereon instructions that when executed cause the processor to:
receive audio input through the microphone, wherein the audio input comprises speech from the user;
receive video input through the facial camera, wherein the video input indicates a face of a user;
provide the audio input and the video input to an AI software application, wherein the AI software application analyzes speech patterns and linguistic characteristics within the audio input and a facial expression of the user indicated within the video input;
determine a synchronized response based on the speech patterns, linguistic characteristics, and facial expression, wherein the synchronized response is a coordination of conversational audio output, at least one facial image, and a gesture including robotic movement to interact dynamically and conversationally with the user; and
deliver the synchronized response as speech output through the speaker, a facial expression presented to the facemask, and robotic movement generated by at least one mechanism of the companion robot.

20. The companion robot of claim 19, wherein the AI software application further performs a cognitive impairment assessment based on the speech patterns, linguistic characteristics, and the facial expression of the user, wherein the cognitive impairment assessment indicates a level of cognitive function of the user;
wherein the synchronized response is further based on the cognitive impairment assessment; and
wherein the gesture of the synchronized response comprises at least one of neck movement generated by the neck mechanism and arm movement generated by the pair of arm and shoulder mechanisms.
